(19) United States
(12) Patent Application Publication
(10) Pub. No.: US 2026/0167582 A1
(43) Pub. Date: Jun. 18, 2026

(54) METHOD FOR IMPROVING NITROGEN ABSORPTION IN PLANTS

(71) Applicant: David DEMAREY, Westhampton, MA (US)

(72) Inventor: David DEMAREY, Westhampton, MA (US)

(21) Appl. No.: 19/535,216

(22) Filed: Feb. 10, 2026

Related U.S. Application Data
(63) Continuation of application No. PCT/US2025/016455, filed on Feb. 19, 2025.
(60) Provisional application No. 63/555,192, filed on Feb. 19, 2024.

(51) Int. Cl. C05F 11/08; C05F 17/20; C05F 17/50; C05G 3/90

(52) U.S. Cl. CPC C05F 11/08; C05F 17/20; C05F 17/50; C05G 3/90

(57) ABSTRACT

A method and composition of promoting the growth of plants is provided. The composition is a culture including a high concentration of plant growth-promoting bacteria. The culture is raised under conditions of high ammonia, high pH and low oxygen to promote the growth of plant growth-promoting bacteria and suppress the growth of methanogens and fungi. The culture is spread on a variety of crops to replace or supplement the use of conventional fertilizers.

### RELATED APPLICATIONS

This application is a continuation of PCT Application Serial No. PCT/US2025/016455, filed Feb. 19, 2025 and titled METHOD FOR IMPROVING NITROGEN ABSORPTION IN PLANTS, and claims benefit of U.S. Provisional Application No. 63/555,192, filed Feb. 19, 2024. The contents of these applications is hereby incorporated by reference in their entirety herein.

### TECHNICAL FIELD

The technical field relates generally to improving plant growth and, more particularly, to methods of increasing available nitrogen, phosphorus, and other macro and microelements for crops.

### BACKGROUND

Nitrogen applied as a fertilizer to plants is used for agricultural purposes to increase the amount of nitrogen for plant intake for their growth and reproduction. Manures, composts, legume cover crops and various other sources of nitrogen are used in agriculture, and these do supply varying levels of nitrogen per acre to the crops.

Composts and manures when applied at high levels, can meet the nitrogen requirements of some crops but the logistics and costs of handling tens of tons of organic nitrogen sources per acre as well as the limited nature of the organic material supply, makes reliance on organic manures impractical in intensive agriculture.

Legume cover crops can provide significant nitrogen to the soil, about 80-150 pounds of nitrogen per acre but can do so in intensive agriculture only when the cover crop is the primary crop grown in the growing space. Nitrogen requirements for commercial agriculture run from a low near 120 pounds per acre up to levels near four hundred pounds of mineral nitrogen per acre.

Science has provided tools, including large scale bacterial culturing, that have opened the door to increasing nitrogen fixation by preparing inoculates of specific bacterial and fungal organisms that are applied to the soil around the roots and occasionally to the seeds of a new crop. Mycorrhizal fungi and various bacteria are mass cultured and then applied assuming that the bacteria and fungi will colonize or live adjacent to the roots of plants and work to aid in mineral uptake and to fix nitrogen from the air. This may work to a slight degree and there are claims to that effect, but none of these cultures come close to meeting the entirety of nitrogen demand in commercial agriculture.

### SUMMARY

Disclosed herein is a process and material that increases the growth of a target crop without the addition of large amounts of nitrogen and/or phosphorus containing fertilizer. This can be accomplished by creating a unique culture of nitrogen fixing and mineral dissolving bacteria, believed to be descendants of an ancient family of bacteria in the Proteobacteria, Firmacutes, Actinobacter and bacterioidota families. These organisms are referred to herein as plant growth-promoting bacteria (PGPB) and include ammonia oxidizing bacteria, nitrate reducing bacteria, and bacteria that include monooxygenase (AMO), nitrogenase (nif), urease or Dissimilatory nitrate reduction genes. In some cases, the PGPB organisms are endophytes that live within the roots of the plants they are nourishing. The organisms can be strongly attuned and adapted to a target crop but can also exhibit near universal effects on all crops both cultivated and wild.

Selection for these nitrogen fixing and mineral nutrient releasing bacteria can be initiated by utilizing and incorporating naturally occurring bacteria derived from a targeted crop or alternately by utilizing soils and/or rock powders as a bacterial source. The nitrifying system is produced by mixing plant material containing the attendant symbiotic bacteria, with other organic food sources, and, optionally, with inorganic matter. This mixture is then cultured in a high ammonia environment that favors PGPB and retards the growth of other microbes such as methanogenic organisms, heterotrophic decomposing bacteria and fungi. The material developed by the process can be applied to plants such as fruit and nut trees, grasses, maize, non-agricultural land and vegetables. The material produces increased plant growth by improving nitrogen adsorption and mineral nutrient capture by 2X, 3X, or more. Due to the microbial action, the increase in nitrogen adsorption can be many times the amount of nitrogen available in the culture itself that is applied to the crop. The culture can also improve and enhance absorption of many plant nutrients such as potassium, calcium, phosphorus and trace metals.

The nitrogen fixing properties of these PGPB, acting on and reducing the need for exogenous nitrogen fertilizers, enables a drastic and significant reduction in the use of commercial nitrogen and phosphorus based fertilizers.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments and are incorporated in and constitute a part of this specification but are not intended as a definition of the limits of any particular embodiment. The drawings, together with the remainder of the specification, explain principles and operations of the described and claimed aspects and embodiments. In the figures, each identical or nearly identical component that is illustrated in various figures is represented by a like numeral. For purposes of clarity, not every component may be labeled in every figure.

FIG. 1 is a block diagram of an example method for producing a culture according to some embodiments of the present disclosure;

FIG. 2 is a table showing the ingredient mix for one embodiment of a culture;

FIG. 3 provides results showing the yield for application of one embodiment of a culture on walnuts and almonds;

FIG. 4 provides results showing the yield for application of one embodiment of a culture on rice;

FIG. 5 provides results showing the yield for application of one embodiment of a culture on prunes; and

FIG. 6 provides results showing the yield for application of one embodiment of a culture on hay.

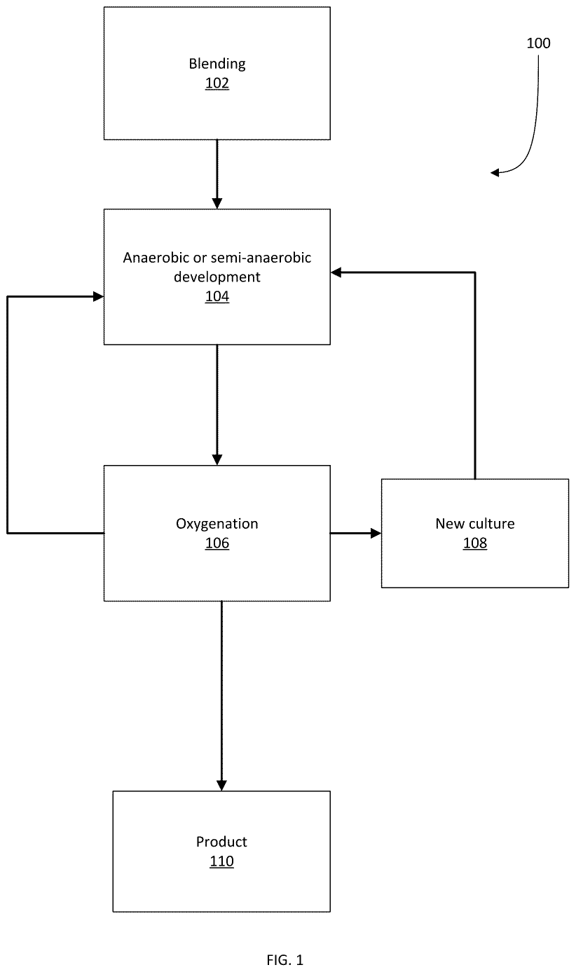

### DETAILED DESCRIPTION

The following detailed description is merely exemplary in nature and is not intended to limit the method, the material, or the application of its use.

In one aspect, the disclosed method cultures plant material in a high ammonia environment to produce a product high in PGPB that can provide plant nutrition equivalent to or superior to the plant growth achievable with the same application of conventional fertilizers. The resulting material can be spread on crops using conventional means. The PGPB can facilitate an increase in nitrogen fixation and/or a release of phosphorus from insoluble sources that are inaccessible to plants. Application of the cultured blend has allowed growers to reduce conventional nitrogen fertilizer application by more than 50% while maintaining equivalent or increased yields at lower cost.

It has been found that a high concentration of PGPB can be favorably cultured in a blend that is exposed to high concentrations of free ammonia (NH₃) and/or low concentrations of oxygen. Not only does a high ammonia concentration support the reproduction and growth of PGPB but it also suppresses the growth of competing organisms that are typically encouraged in traditional compositing methods. These competing organisms include decomposing bacteria, methanogenic bacteria, and fungi. In some embodiments, the free ammonia concentration can be maintained at greater than 100 ppm, greater than 200 ppm, greater than 500 ppm, greater than 1000 ppm, greater than 5000 ppm or greater than 10,000 ppm. These levels can be maintained during all, or a majority of the culture time. For example, if a blend is cultured for one month, the free ammonia concentrations can be maintained for at least three weeks or at least two weeks. In other embodiments, the free ammonia concentration is maintained for greater than 50%, greater than 75% or greater than 90% of the culture duration. Free ammonia as a percentage of total ammonia (include ammonium ion) can vary depending on, for example, pH. In various embodiments, the average ammonia content can be greater than 100 ppm, greater than 500 ppm, greater than 1000 ppm, greater than 10,000 ppm or greater than 50,000 ppm. As used herein, ammonia levels, pH, moisture, oxygen and other parameters that may be measured in the culture are an average of values contained throughout the mass. For example, ammonia levels may be higher on the interior of a blend than on the outer surface, and an average value for a parameter is the average taken throughout the blend.

In one aspect, the oxygen level in the blend is regulated. Low oxygen levels encourage the growth of anaerobic organisms and discourage the growth of aerobic ones. During production, oxygen levels can be cycled to produce periods of anaerobic activity alternating with aerobic activity. In various embodiments, oxygen can be limited in the culture to less than 21% (atmospheric), less than 20%, less than 10%, less than 5%, less than 2%, less than 1%, less than 0.1% or less than 0.01%. Oxygen is typically reduced by preventing access to the atmosphere and is increased by provided access to atmosphere, such as by mixing or injecting air.

It has been found that a high pH can be conducive to the growth of PGPB and the suppression of non-PGPB organisms. For example, pH can be maintained at greater than 7.0, greater than 7.5, greater than 8.0, greater than 8.5, greater than 9.0, greater than 9.5, greater 10.0, greater than 10.5 or greater than 11.0. At a higher pH, the proportion of free ammonia as a percentage of total ammonia is increased, and therefore a higher pH can lead to a greater free ammonia concentration at an equivalent total ammonia concentration. As with free ammonia, these pH levels can be maintained for greater than 50%, greater than 75% or greater than 90% of the culture duration.

Moisture can be important for the growth of the PGPB population. Moisture content can be adjusted according to the amount of organic material in the blend. For instance, blends that include 90% rock dust require less water than do blends having no rock dust. Based on the amount of plant material in the blend, the amount of moisture by weight in the culture can be, for example, greater than 5%, greater than 10%, greater than 20% or greater than 30%. Based on the total mass of the blend, the amount of moisture by weight in the culture can be, for example, greater than 1%, greater than 5%, greater than 10%, greater than 20%, less than 50%, less than 30% or less than 10%. Water can be added at the start of the process and can be supplemented during production.

In some embodiments the culture benefits from a high concentration of halide ions. It is believed that the halides retard the growth of competing bacteria while the PGPB are able to thrive under high halide concentrations. Specifically, some or all of the PGPB can be thermophilic halophytes that thrive at high temperatures and high salt concentrations. Halides can be present in components of the culture or may be added, for example, when water is added to the mix. For example, a culture can be brought up to 10% moisture by adding a solution of sodium chloride to arrive at a chloride concentration of 1% by weight. In some cases the PGPB are viable at a chloride, bromide, fluoride and/or iodide concentration, or halide concentration as a sum, of greater than 100 ppm, greater than 1000 ppm, greater than 10,000 ppm, greater than 50,000 ppm or greater than 100,000 ppm. Measurements are made on a wt/wt basis and can vary with the amount of moisture in the culture.

The culture typically operates at an elevated temperature and can be self-sustaining. In some embodiments, the temperature can exceed 40° C., greater than 50° C., greater than 60° C. or greater than 70° C. The process can be stopped if the temperature exceeds a particular value, such as 50° C., 60° C. or 70° C. In other embodiments, the culture can be maintained at ambient temperature, but this typically extends the required culture time.

Culturing methods can be done in a static or dynamic system. For instance, a blend can be formed into windrows or piles, such as conically shaped piles to minimize the intrusion of atmospheric oxygen. In other embodiments, the blend can be placed in a rotary reactor where it is constantly or intermittently rotated to assure mixing. In such a reactor, parameters such as moisture, oxygen, ammonia and pH can be controlled and adjusted. In other embodiments, the blend can be formed on an aerated floor and air flow through the floor can be controlled to regulate oxygen content and favor optimum oxygen concentrations in the culture. In other embodiments the culturing process can proceed in a liquid reactor or as a semisolid, dispersion or suspension.

Blend ingredients can be combined and cultured in ways that maximize the growth of PGPB and minimize the growth of undesired organisms. For example, the ingredients can be added to a pre-mixer and completely mixed. This mix can include plant material, bacteria, ammonia (e.g., urea) and fly ash. This mixed material can then optionally be combined with any carrier that is to be used, such as rock dust or iron containing clay. The mixed material can be transferred to a conveyor belt where rock dust and any other inorganic material can be added. This combination of materials can then be comminuted to reduce the size of any large particles. For instance, the material can be run through a hammer mill that reduces particle size to less than %2 inch, % inch or %$ inch. Moisture can be added at this stage and at any point during the process. For example, after mixing, the material can be adjusted to 5% or 10% moisture by weight. The material can then be allowed to sit for a period of time, e.g., one week, before it is moved to another location. This movement can result in oxygenation due to air exposure. The material can be turned over intermittently, for instance every week, until it has reached a predetermined value, such as a temperature, a pH, an ammonia level, or a particular PGPB count. The material is now fully cultured and can be stored or shipped for use. It has been found that the PGPB retain their viability for many months, even in a dry state.

If the material is cultured in a dynamic system, such as a rotary reactor, parameters such as ammonia, oxygen, pH and moisture can be more accurately monitored. Additives such as ammonia and water can also be easily added in a rotary reactor. This can lead to faster production and may take less than a month, less than two weeks or less than one week. If the culturing process proceeds in water the culture can be constantly or intermittently monitored and adjusted for ammonia content, pH and oxygen levels.

### Blending

### Target Crop

In some embodiments, the plant materials chosen can be from the same target crop as that to which the culture will be applied. In other cases, the plant materials can be mixed and may optionally include the target plant material in the mix.

In some embodiments, the target crop materials can be obtained from crops grown under low mineral nitrogen applications. Some examples of crops include wheat, corn, rye, alfalfa, various nut trees, pasture grasses, etc. Plant materials can be fresh material or waste products from the crop.

In some embodiments, the plant materials can contain a carbohydrate source in the form of sugars or cellulose and a small amount of organic nitrogen in the form of proteins or other nitrogen containing plant products. In some embodiments the target crop materials used can have a carbon to nitrogen ratio greater than 1/1, greater than 10/1, greater than 20/1, greater than 40/1, greater than 50/1, up to 100/1.

This organic matter from the target crop may contain live bacteria, Archaea, and/or fungi, or their spore forms, that can perform a nitrogen cycle process in the target crops. The nitrogen cycle organisms are procured by incorporating some level of the target crop's plant material containing the attendant symbiotic bacteria. Nitrogen cycle organisms can include nitrogen fixing bacteria, nitrifying bacteria, and denitrifying bacteria. Also, depending on the target crop, the plant material can include Alpha Proteobacteria or a number of other mineral nutrient supplying bacteria in the Firmacute and Actinomyces genus. If the bacteria are not present, they can be added to the plant material via live plant matter introductions or use of a “seed” of the bacteria from a previous run of the culture. The plant material is cultured in a manner that enhances the growth of nitrogen cycle and nutrient mining organisms and strongly suppresses interference by other non-PGPB anerobic methane producing bacteria and fungus. The organic portion (plant material, e.g.) of the mixture can be used as a food source for the nitrogen-fixing bacteria, nitrifying bacteria, and denitrifying bacteria throughout the method as described below.

### Inorganic Substrate

In some embodiments, the culture, containing the plant material, can be augmented with an inorganic mineral substrate providing a bulking agent, macronutrients and source of trace minerals for the PGPB, and a pH buffering action to the culture. In some embodiments, trace metal supplements can be directly added to the mix either as solids or aqueous solutions. Some mineral substrates can serve as a source of the beneficial bacteria that are grown and amplified in the culture. A mineral component of the blend can be, in various embodiments, a solid or liquid mineral supplement, sand, gravel, crushed stone, soil, clay or sediment. In a specific example, the inorganic substrate is rock dust. Rock dusts are processed fines resulting from quarrying and crushing operations, or fines from specific mining or industrial operations that do not contain harmful substances. The rock dust used can be manufactured purposely from a quarry face or deposit, crushed to size, and used exclusively to make the rock component of the blend. The rock dust derives from a rock type that contains a sustaining level of essential trace metals for the plants and can support the biological functions of nitrogen-fixing bacteria and Nitrifying bacteria. The essential trace metals need not be in a bio-available form in the rock dust, but there should be some level of intrinsic solubility of the nutrients such as the level of availability of nutrients as determined by a soil test, e.g, Mehlich III, soil nutrient extraction method. Example rock types include basalts, shales, some granites, various sedimentary rock types, zeolites, and mantel rock types such as olivine. Individual rock types or combinations of differing rock types can be used. The inorganic substrate, in this case rock dust, can contain greater than 0.01, 0.1, 0.2, 0.5, 1.0 or 2.0% or higher by weight of iron and/or manganese, and greater than 0.0001, 0.01, 0.1, 0.2, 0.5 or 1.0% copper and/or zinc by weight. In various embodiments, particle size can be, for example, less than 2 cm, less than 1 cm, less than 5 mm or less than 2 mm.

In some embodiments, the ability of the rock dust to resist acidification and provide an acid buffering action can also be a considered criterion to determine the choice of rock dust or the use of any inert materials. Anaerobic deep sea deposited shales, especially those containing carbonates, can be useful for pH buffering and as a trace metal source.

The mineral component composition can be specified to have a pH buffering ability that creates an upper and lower pH bound that the culture can reach. The buffering process can also be controlled by adding small amounts of a buffer such as sodium bicarbonate, sodium carbonate or potassium carbonate, but utilizing carbonates from the rock dust in the mix avoids the needs for other pH additives. Buffering ranges can include pHs of greater than 7, greater than 8, from 7-8, from 7-9, from 7.5-9, from 8-9 and from 8-11.

These other inorganic or organic materials can participate actively in the culture process or simply serve as bulking agents or diluents for the culture process. Examples of these types of materials include biochar, silica sand, perlite, vermiculite and other inorganic sources as well as some partially decomposed organic materials such as an aged compost.

### Nitrogen Source

A nitrogen source, such as urea, can be added to the mix, for example, to provide a nitrogen source for bacteria (urease) to transform into ammonia. In some embodiments, nitrogen can be applied exogenously to the blend as mineral nitrogen such as an ammonium salt, e.g., ammonium nitrate, or other compound that includes an ammonium group, such as urea or even ammonia itself. This added nitrogen allows for an increased upper limit of the carbon-nitrogen ratio in the plant materials used.

### Blending Process

In some embodiments, a portion of the target crop is blended with finely ground rock dust and, optionally, other filler. The blending ratio of the culture for the mineral component can be as low as zero percent by weight of the rock mineral component, up to ninety eight percent of the mineral component. In certain embodiments, the blending ratio of the target crop may be zero (0) percent by weight at a minimum for the target crop material or a starter charge from a previous culture run, up to one hundred (100) percent by weight of the target crop products. For purposes of the present method, the amount of mineral component added to the blend has an inverse effect on the amount of the target crop used. For example, the blend can only have 98% of its weight be the mineral component means that, at most, only 2% of the weight of the blend can be the target crop. On the other hand, if the blend has 100% weight from the target crop, then 0% of the blend's weight can be for the mineral component. In other embodiments, the mineral component and the plant material (target crop) can make up less than 100% of the blend. Other components can include, for example, soil, compost, other plant products, pH adjusters, water and additional microbes or insects.

In some embodiments, the weight range for the mineral component may be between ten (10) and ninety-five (95) percent by weight of the blend. The range for the target crop products can be between zero (0) percent by weight of the blend up to one hundred (100) percent by weight of the crop products.

In some embodiments, after blending the organic materials and the rock dust component with the organic portion, the blend may be ground to a reasonable degree to pass a screening device of no larger than % inch.

In an alternate embodiment, the blend may be ground to % inch and under in the thickest dimension.

### Anaerobic and Aerobic Environment Cycle

### Anaerobic Environment

In some embodiments, an anaerobic condition can be achieved in a traditional anaerobic digester setting or developed in other ways that seal off the culture from oxygen in the air. The method can cycle between aerobic and anaerobic or semi-anaerobic conditions. Initially, upon mixing, there may be oxygen from the air in the chamber or mass, and within the pore space of the mixture. The free oxygen may be consumed by the aerobic respiration of bacteria and fungi to produce carbon dioxide and drive the culture into the initial stages of the anaerobic process.

In some embodiments, the loss in oxygen allows certain bacteria to start producing or releasing ammonia from the available nitrogen sources in the culture. This increase in ammonia production, in turn, increases the pH of the environment. Throughout the anaerobic process, the culture can reach a pH of from 8.5 to 11 with a final pH of around 7.7-8.3 in a dried state or pH 9 or higher with moisture present. Various embodiments, when cultured, may have a pH of greater than 8.5, greater than 9.0, greater than 9.5, greater than 10.0, greater than 10.5 or greater than 11.0.

In some embodiments, the buffering capability of an inorganic additive can limit the fall in pH experienced at the beginning of the anaerobic process, and the presence of alkalinity has a bearing on the choice of rock dust, as mentioned earlier. If buffering does not limit acidification using rock dust alone, then an external buffering system, or alkaline source, may be applied to the culture. Buffers can include, for example, sodium carbonate, sodium bicarbonate, sodium phosphate, sodium biphosphate, sodium triphosphate and various Carbonates of Potassium. Alkaline sources can include, for example, sodium hydroxide or crushed limestone.

In alternate embodiments, the process can raise the pH of the culture without the addition of buffering or alkalizing agents. For example, the rise in pH of the culture can be driven by ammonia production, adding ammonia, adding an ammonium/ammonia source, such as an ammonium salt, e.g., ammonium sulfate or ammonium carbonate, or by adding an external buffering system or alkaline source. The rise in pH progressively shifts the equilibrium away from ionized non-toxic ammonium ion towards non-ionized free ammonia. This shift toward free ammonia inhibits most anaerobic bacteria, including the methanogenic (Methane generating) bacteria and most fungi. Free non-ionized ammonia NH₃ is toxic to most bacteria at just 2 ppm at a pH of 9.5 while methanogens become strongly inhibited by free ammonia levels beyond a few hundred parts per million and are at a near total shut down in growth by 750 to 1000 ppm ammonia. The culture process described herein routinely reaches a pH above 10, at which point, 90% of the total ammonia present may be in the form of free ammonia and can reach as high as 20,000 ppm. At this level of ammonia and pH, the methanogens, fungi and other bacteria are inhibited, while the PBGB are able to grow at the high pH and ammonium levels of the culture. This increase in ammonia levels is contrary to known practices of anaerobic culturing.

In other embodiments, methanogens and other bacteria can be inhibited at a very low ratio of free ammonia to ammonium if the concentration of Total ammonia Nitrogen (TAN) is very high. This is because it is the free NH3 level of ammonia that controls the process. For example, methanogens and other bacteria are inhibited at a TAN of 5000 ppm with a ratio of 1/10 ammonia to ammonium.

This inhibition of methanogens, most fungi, and many anaerobic and aerobic bacteria may prevent the competition between them and the Nitrifying and mineral nutrient releasing organisms for the biomaterials in the culture. Another benefit of the selective inhibition of competitor organisms (e.g. bacteria and fungi) is that it leaves the food source in the form of sugars and cellulosic components from the organic portion of the mix, available primarily to the nitrogen cycle and nutrient releasing organisms for their use and growth.

The loss of oxygen, initially present in the mixture, impacts the growth of the nitrifying and denitrifying bacteria by inhibiting their ability to metabolize. The nitrifying organisms of the culture, many of which are facultative anaerobes, now move to an alternate respiratory cycle available to them in which they use an anaerobic metabolic pathway to extract needed oxygen from organic acids and the proteins held in the organic part of the mix as well as any oxidized forms of nitrogen such as nitrate or nitrite (for the denitrifying bacteria and nitrifying bacteria, respectively) or other oxidized nitrogen species. Additionally, the reduction in organic acids, by the nitrogen cycle organisms, can increase the pH during the anerobic process.

Almost all bacteria and fungi assimilate only simple (mineral) forms of nitrogen. They may not grow if the nitrogen is locked up as complex biological nitrogen. When the culture may be spread on a crop, any ammonia rapidly evaporates and with all other nitrogen sources tied up in the bodies of the microorganisms of the culture, it lengthens the time the applied nitrifying and nutrient releasing organisms can persist in the environment and increases the chance for crop inoculation by the bacterial species.

In some embodiments, the ammonia and anaerobic conditions can act together to create a reducing atmosphere and environment with low ORP (Oxidation Reduction Potential) within the mixture that favors valence reduction and better solubility of the metals in the rock dust and encourages the reduction of any metals in the rock or mineral assemblage. An active anaerobic (less than 0.5% oxygen) or partially aerobic (less than 10% oxygen) environment can reach ORP values between −100 mV and 85 mV. The reduction occurring in this step may be a function of the reduced oxygen tension of the culture coupled with the production of reducing species by the bacteria acting on the organic substrate and attacking the exposed surfaces of the rock dust.

It is also believed that the buildup of ammonia/ammonium aids in complexing and dissolving metals, making them more available to the PGPB in the culture. This reduction in valence of metal compounds subsequently allows the dissolution of the trace metals in the inorganic material to render the metals available to the nitrogen-fixing bacteria and encourages their growth. For example, the degree of availability of ferrous or ferric ion, which is needed for bacterial growth, may be increased by the anaerobic or partially aerobic treatment and the ammonia development in the culture. The process can, for example, reduce iron oxide to more available forms of iron such as Fe⁻² and Fe⁻³ (in the presence of an Iron complexing component like a siderophile). Additionally, this process can help convert metal oxides and silicates in the trace metal to accessible metal salts.

The ammonia can help stabilize the culture and puts the culture into a stasis that can last until the ammonia is lost from the culture by volatilization or direct evaporation once the culture is exposed to the air.

### Aerobic Environment

In some embodiments, when the culture has entered a state where ammonia has inhibited all or almost all anaerobic bacteria, methanogens, and fungi, oxygen may be reintroduced to the process. Oxygen can be introduced by mixing and agitating the mixture in atmospheric conditions or by injecting air into the culture. This process is continued until the environment around the culture moves from the anaerobic to the aerobic state. This is determined by a measurable increase in the oxygen content of the culture. This addition of oxygen now allows the least ammonia inhibited bacteria, the nitrifying Archaea, bacteria, and fungi, to consume the organics in the culture utilizing it as a biomass-building source.

In some embodiments the oxygen content of the culture is lowered but not to the point of a completely anerobic culture. Lowered oxygen tension developed in the culture can create optimum condition for the nitrogen fixing and nutrient releasing bacteria to function.

In some embodiments, the oxygenation process in the aerobic environment can last for a period of time that depends on the level of mixing and agitating of the culture. For instance, a higher level of mixing will lead to the culture needing less time to oxygenate. Thus, the oxygenation process can take a few minutes to a few days to complete.

In some embodiments the culture is held in a steady state of reduced oxygen tension or concentration.

### Reestablish the Anaerobic Condition

In some embodiments, if sufficient organic matter, along with a nitrogen source, as described earlier, is available, then the closure of the chamber holding the culture isolate the culture from oxygen allowing the anaerobic or near anerobic process to recur and more ammonia to be produced. A sufficient nitrogen source can be determined if there is there is at least 0.05% of nitrogen by weight of the final mix in the form of plant proteins is present in the culture. Additionally, if there is not enough mineral nitrogen in the final mix then a nitrogen source can be added to the mix to reestablish the Anaerobic or near anerobic condition.

In some embodiments, if sufficient levels of the sources of oxidized nitrogen, such as nitrate, nitrite, or other oxidized nitrogen species, or the target crop's reducible organic compounds are not in the body of the culture due to loss in the initial anaerobic phase, then small amounts of mineral nitrogen, such as nitrate or an ammonia source such as ammonia, Urea or an ammonium compound, can be applied to the culture. The minimum levels of mineral nitrogen needed per cycle may be between 10\hat{ }-3 and 10 \hat{ }-2 Molar, but there must be enough to run each process cycle and an excess does not hurt the Nitrifying organisms. Running multiple cycles can require 10\hat{ }-1 Molar Nitrogen or 1400 ppm N based on the weight of the culture.

In an alternative embodiment, the minimum levels of mineral nitrogen (NH₄, NO₃, or Urea) can range from 0.02 to 2 Molar.

In some embodiments, this anaerobic to aerobic environment cycle can be repeated numerous times with a minimum of one time and with a yet undetermined upper limit of process cycles. The process can be stopped when the culture stops increasing in temperature after surpassing 131° F. For instance, in some embodiments when the core temperature of the culture material gets to about 150° F., the temperature will plateau and production can be ceased. Other maximum temperatures can be, for example, 115, 120, 130, 140, 150, 160 or 180° F.

### Salt

In some embodiments salt can play a role in inhibiting the bacteria and fungi that would compete with the nitrogen fixing and mineral nutrient releasing/solubilizing bacteria that are favored by this culture method. The salt, such as mineral salts or natural sodium or potassium chlorides or various grades of sea salt combine synergistically and in some cases act similar to ammonia in favoring the growth of the desired nitrogen fixing and nutrient mining bacteria. It is expected that many of the bacteria grown by this ammonia selective method are also halotolerant by nature and the osmotic and ionic effects of salts acts to further the selectivity of the culture method. As used herein, a bacteria is halotolerant if it can reproduce in an environment containing greater than 0.5% salt, by weight. In some embodiments the salt concentration present in the culture would range from 300 ppm expressed as halide ion up to 150,000 ppm expressed as total salt.

In some embodiments, elevated levels of salts serve to stabilize and preserve the culture from degradation after the ammonia is lost from the culture by evaporation or consumption by bacteria or fungus. For example, 5,000 ppm, 10,000 ppm or 100,000 ppm salt can suppress the growth of non-PGPB bacteria and fungi in the absence of ammonia. It is notable that even 10% salt does not have an effect on the plants with which the culture is used because so little of the culture is required to be effective.

### Product

In some embodiments, the application rates of applying the nitrifying cultures to crops may depend on the number of active species within the blend and the time of year of applying the culture to the crops. Increasing the crop-specific portion of the culture may be expected to increase the inoculation efficiency of the culture. Increasing the percentage of the target crop material in the culture may carry a higher level of beneficial nitrogen cycle organisms and increase the proportion of the desired bacteria and fungi in the culture. This, in turn, can increase the rate of buildup of those organisms in the culture and lead to a culture with a higher inoculation efficiency. The increase in the target crop portion is limited to the amount of the other components needed to develop the anaerobic culture selective for the nitrogen cycle organisms.

Rates of application of the resulting nitrogen fixing cultures can vary widely, depending on the inherent strength of the culture. Application rates to a crop can rely on the analyzed and quantified levels of the nitrogen cycle and nutrient releasing organisms and the results of an efficacy test run on each crop.

In some embodiments, the culture can be diluted by the mineral component to lower levels of bacteria concentrations dictated by an application rate per acre of the active species desired for the target crop. This would be done, for example, if mineral application to the land would be required to provide macronutrients or alkalinity. If no other trace metal or macronutrients are needed to be applied, then the minimum volume per acre of the blend can be driven by the minimum blend volume required to gain good distribution of the product. That value can also be dependent on the native strength of nitrogen cycle organisms and the amount of those organisms needed per acre.

In an alternative embodiment, adding a portion of one culture to the next culture blend using the same plant source can select for higher levels of the most efficient nitrogen cycle organisms. This seeding process can develop a high-efficiency culture product that allows for shorter production times to equivalent levels of beneficial microorganisms. This heightening of the efficiency of the inoculant can allow lower application rates of the nitrogen fixing culture to develop.

In some embodiments, the application rates of the cultures to crops depend on the time of year. The culture, as mentioned above, likely contains bacteria that evolved with land plants. These bacteria can fix nitrogen from the air within the plant tissues and work in conjunction with the plants to mine the soil for needed nutrients and trace metals. This symbiotic relationship depends on the plants producing sugars that can feed the bacteria that fix the nitrogen and dissolve the rocks in its environment. Some PGPB are endophytes or “living within” the plant's leaves, fixing nitrogen, while others form associations with other bacteria along with the plant roots, where the plants provide sugars and other nutrients to support the rock-dissolving bacteria. The nutrients, provided by these bacteria, can only be absorbed through new roots, and without new roots constantly forming, the plants can absorb only water.

The plants can partition sugars at various times of the year in deference to the various life functions of the plant. This applies to the roots where, in mid to late summer, the sugars and nutrients are directed towards fruiting and not to the roots. The plants can have this partitioning effect where there may be only a certain amount of sugar available to be doled out to the plant itself or its symbiotic bacterial cohorts, depending on the time of the year. In other words, if nitrogen is limited, then plants must devote sugar and energy to obtaining nitrogen. In that case, the plant partitions the sugar to the leaves and their nitrogen-fixing bacteria. The roots may not then acquire sugar from the leaves to, in turn, give sugar to the bacteria that dissolve the rocks to provide, for example, potassium to the plant. Without adequate potassium, plant growth and sugar production are slow. In effect, there can be a powerful feedback loop that governs the total acquisition of plant nutrients and limits overall growth. This feedback loop can serve to function as a gatekeeper for overall growth, doling out sugar to where it may be needed the most and limiting plant growth when essential nutrients from the soil come up short.

As a result, the efficiency and magnitude of the rock dissolution abilities of the plant are regulated or throttled by two processes, the rate and efficacy of nutrient release by the applied bacteria based on their applied numbers and efficiency of dissolution and second by a feedback loop where the plant provides an amount of sugar to the nutrient releasing bacteria and Nitrogen fixing bacteria in proportion to the plant nutrient availability. The culture steps of using alternating anaerobic and aerobic environments acts on the rock dust can enhance this nutrient availability and provide plant-adapted rock-dissolving bacteria that continue to act on the applied rock dust and go after the rock already in the crop soil. Providing a source of dissolvable fresh rock and bacteria made in the culture can increase the availability of plant sugars to grow the rock-dissolving bacteria that can increase plant growth.

### Aerobic Culture of Nitrogen Cycle Organisms.

In an alternate embodiment, the culture of the nitrogen cycle organisms beyond the anaerobic culture methods described in this method can be achieved under aerobic or semi conditions. The aerobic conditions, if used following “normal” culturing procedures, can utilize mineral forms of nitrogen such as ammonium and nitrate along with trace metals and a food (carbohydrate) source. When this culturing procedure is attempted using raw plant products as a source for the nitrogen fixing organisms, it becomes impossible to isolate and grow the nitrogen cycle organisms at a useful concentration because of the interference of competing bacteria and fungi. Just as ammonia developed by anaerobic methods in the previously described protocols inhibits competition by methanogens, fungi, and other bacteria, it can also be used to select for the nitrogen cycle and nutrient releasing organisms if applied to an aerobic or semi aerobic system by external application.

The amount of ammonia applied in the aerobic case may be within the parameters needed in the anaerobic case or near 300 to 5000 ppm or higher as free ammonia. This can be obtained by ammonium concentrations that are much higher than 300 to 1000 ppm to reach a possible 15000-20,000 ppm as TAN (Total ammonia nitrogen) and depending in turn on the pH of the system in which high pH yields a higher proportion of un-ionized free ammonia. The actual upper limit for TAN and free ammonia (NH₃) has not yet been determined or reached but experimental evidence indicates it is higher than 20,000 ppm as free ammonia expressed as ammonia or TAN as related to pH.

In some embodiments, this aerobic and semi aerobic processes do not require cycling between anaerobic and aerobic conditions. However, such cycling would not likely hurt the selection or amplification of the nitrifying and nutrient releasing organisms in the culture.

### Co-Reactants

In some embodiments, ammonia can be added to the culture to support the growth of nitrogen cycle organisms. The added ammonia, at a sufficient strength, can lessen or even eliminate competition from methanogens, fungi, and other bacteria for the purposes described above. ammonia can be added, for example, at concentrations of greater than or equal to 0.001%, 0.01%, 0.1%, 1.0%. 2.0% or even higher.

Fostering the conditions within the culture medium conducive to trace metal dissolution requires co-reactants that can keep the ORP at low values and complex or solubilize Iron at the pH of the aerobic ammonia-containing system. In some embodiments, reducing agents like ascorbic acid, oxalic acid, sulfites, etc. can fill both functions by acting as a reducing agent for Iron and a complexing agent for Iron. Ascorbic Acid can be incorporated into the culture medium at the level of 0.5 to 1 mole of ascorbic acid per mole of total trace metals.

In many embodiments, PGPB that are grown in the culture are not present in the native soils to which the culture is added to improve crop production. Examples of PGPB that have been successfully grown under anaerobic, ammoniac conditions include:

### Facultative Anaerobes

Pseudogracilibacillus auburnensis, Staphylococcus lentus, Enteractinococcus sp., Pseudogracilibacillus endophyticus, Sinibacillus sp., Atopostipes sp., Jeotgalicoccus sp., Oceanobacillus indicireducens, Dietzia aerolata, Oceanobacillus sp., Nocardiopsis dassonvillei, Streptomyces griseus, Streptomyces albus, Streptomyces albidoflavus, Paeniglutamicibacter sulfureus, Saccharopolyspora rectivirgula, Brevibacterium sp., Saccharopolyspora sp., Nocardiopsis composta, Rhodococcus erythropolis, Nocardiopsis salina, Streptomyces aculeolatus, Saccharopolyspora gregorii

### Anaeraobic Bacteria

Anaerosalibacter bizertensis, Caldicoprobacter sp., Tepidimicrobium sp., Anaerosalibacter massiliensis.

### Aerobic Bacteria

Sporosarcina sp., Pseudogracilibacillus endophyticus, Virgibacillus sp., Plariflum composti, Brachybacterium paraconglomeratum, Georgenia sp., Glutamicibacter nicotianae, Sphaerobacter thermophilus, Nocardiopsis sp., Filomicrobium sp., Haloactinobacterium album, Saccharomonospora viridis, Glycomyces mongolensis, Novibacillus thermophilus, Plarufilum sp., Oceanobacillus sp., Nocardiopsis dassonvillei, Saccharomonospora azurea, Caldalkalibacillus sp., Kroppenstedtia eburnea, Rhabdanaerobium thermarum, Oligoflexus sp., Thermoactinomyces khenchelensis, Mycolicibacterium thermoresistibile, Laceyella sacchari, Thermocrispum municipale, Caldalkalibacillus uzonensis, Cellulosimicrobium cellulans, Patulibacter sp., Thermoactinomyces sanguinis, Cytobacillus kochii, Thermostaphylospora chromogena

### Nitrogen Fixing Bacteria

Sporosarcina sp., Filomicrobium sp., Nocardiopsis dassonvillei, Streptomyces griseus, Mycolicibacterium thermoresistibile, Streptomyces albus, Streptomyces albidoflavus, Alkalihalobacillus clausii, Bacillus farraginis, Streptomyces aculeolatus

### Bacteria Containing AMOA

Staphylococcus lentus, Sporosarcina sp., Virgibacillus sp., Nocardiopsis sp., Nocardiopsis dassonvillei, Streptomyces griseus, Streptomyces albus, Streptomyces albidoflavus, Paeniglutamicibacter sulfureus, Saccharopolyspora rectivirgula, Brevibacterium sp., Alkalihalobacillus clausii, Rhodococcus erythropolis, Bacillus farraginis, Streptomyces aculeolatus.

The following bacteria are those at significant levels in cultured material that have also been confirmed present in measurable quantities in native soils.

Saccharopolyspora gregorii, Saccharopolyspora rectivirgula, Saccharopolyspora sp., Salinispora sp., Sinibacillus sp., Solirubrobacter sp., Sphaerobacter thermophilus, Sporosarcina pasteurii, Sporosarcina sp., Stackebrandtia endophytica, Stackebrandtia sp., Staphylococcus lentus, Steroidobacter sp., Streptomyces aculeolatus, Streptomyces albidoflavus, Streptomyces albus, Streptomyces griseus, Streptomyces sp., Streptomyces turgidiscabies, Tepidimicrobium sp., Thermasporomyces composti, Thermoactinomyces intermedius, Thermoactinomyces khenchelensis, Thermoactinomyces sanguinis, Thermocrispum municipale, Thermostaphylospora chromogena, Virgibacillus sp.

Table 1 lists the bacteria and their counts, from most to least prevalent, that have been found in cultures using the methods described herein.

TABLE 1

| | Count in |
|---|---|
| Name | CFU/gram |
| Pseudogracilibacillus auburnensis | 1.81E+09 |
| Staphylococcus lentus | 1.44E+09 |
| Enteractinococcus sp. | 1.37E+09 |
| Anaerosalibacter bizertensis | 7.80E+08 |
| Sporosarcina sp. | 6.65E+08 |
| Pseudogracilibacillus endophyticus | 5.70E+08 |
| Bacillus sp. | 3.97E+08 |
| Sinibacillus sp. | 3.50E+08 |
| Virgibacillus sp. | 3.27E+08 |
| Planifilum composti | 3.05E+08 |
| Brachybacterium paraconglomeratum | 2.61E+08 |
| Sporosarcina pasteurii | 2.30E+08 |
| Georgenia sp. | 1.91E+08 |
| Actinomadura sp. | 1.45E+08 |
| Atopostipes sp. | 1.26E+08 |
| Glutamicibacter nicotianae | 1.14E+08 |
| Longispora sp. | 1.14E+08 |
| Sphaerobacter thermophilus | 9.46E+07 |
| Nocardiopsis sp. | 8.39E+07 |
| Jeotgalicoccus sp. | 8.07E+07 |
| Filomicrobium sp. | 7.65E+07 |
| Haloactinobacterium album | 6.58E+07 |
| Saccharomonospora viridis | 6.14E+07 |
| Glycomyces mongolensis | 5.89E+07 |
| Caldicoprobacter sp. | 5.76E+07 |
| Oceanobacillus indicireducens | 5.18E+07 |
| Dietzia aerolata | 4.88E+07 |
| Novibacillus thermophilus | 4.15E+07 |
| Planifilum sp. | 4.08E+07 |
| Streptomyces sp. | 3.60E+07 |
| Oceanobacillus sp. | 3.42E+07 |
| Steroidobacter sp. | 3.13E+07 |
| Thermoactinomyces intermedius | 2.69E+07 |
| Tepidimicrobium sp. | 2.66E+07 |
| Ammoniphilus sp. | 2.36E+07 |
| Pajaroellobacter sp. | 2.32E+07 |
| Rhodococcus sp. | 1.74E+07 |
| Hyphomicrobium sp. | 1.71E+07 |
| Anaerosalibacter massiliensis | 1.69E+07 |
| Nocardiopsis dassonvillei | 1.44E+07 |
| Saccharomonospora azurea | 1.39E+07 |
| Pseudolabrys sp. | 1.32E+07 |
| Caldalkalibacillus sp. | 1.28E+07 |
| Pseudorhodoplanes sp. | 1.04E+07 |
| Micromonospora sp. | 1.02E+07 |
| Kroppenstedtia eburnea | 9.88E+06 |
| Paenibacillus sp. | 9.51E+06 |
| Streptomyces griseus | 8.98E+06 |
| Rhabdanaerobium thermarum | 8.89E+06 |
| Haloactinopolyspora sp. | 8.55E+06 |
| Oligoflexus sp. | 8.48E+06 |
| Thermoactinomyces khenchelensis | 8.21E+06 |
| Conexibacter sp. | 7.75E+06 |
| Kroppenstedtia sp. | 7.60E+06 |
| Mycolicibacterium thermoresistibile | 7.49E+06 |
| Streptomyces albus | 7.31E+06 |
| Streptomyces albidoflavus | 7.06E+06 |
| Paeniglutamicibacter sulfureus | 6.79E+06 |
| Saccharopolyspora rectivirgula | 6.63E+06 |
| Salinispora sp. | 6.49E+06 |
| Ornithinibacillus heyuanensis | 5.90E+06 |
| Brevibacterium sp. | 5.62E+06 |
| Laceyella sacchari | 5.56E+06 |
| Saccharopolyspora sp. | 5.40E+06 |
| Isoptericola variabilis | 4.89E+06 |
| Alkalihalobacillus clausii | 4.86E+06 |
| Nocardiopsis composta | 4.44E+06 |
| Actinopolymorpha sp. | 4.34E+06 |
| Rhodoplanes sp. | 4.22E+06 |
| Planifilum fulgidum | 4.07E+06 |
| Stackebrandtia endophytica | 3.92E+06 |
| Thermasporomyces composti | 3.80E+06 |
| Rhodococcus erythropolis | 3.68E+06 |
| Nonomuraea kuesteri | 3.64E+06 |
| Thermocrispum municipale | 3.52E+06 |
| Novibacillus sp. | 3.20E+06 |
| Stackebrandtia sp. | 2.74E+06 |
| Streptomyces turgidiscabies | 2.71E+06 |
| Caldalkalibacillus uzonensis | 2.64E+06 |
| Solirubrobacter sp. | 2.54E+06 |
| Oceanobacillus caeni | 2.41E+06 |
| Cellulosimicrobium cellulans | 2.39E+06 |
| Patulibacter sp. | 2.25E+06 |
| Nocardiopsis salina | 2.19E+06 |
| Pedomicrobium sp. | 2.15E+06 |
| Thermoactinomyces sanguinis | 2.14E+06 |
| Bacillus farraginis | 2.00E+06 |
| Legionella sp. | 1.94E+06 |
| Actinomadura rubrobrunea | 1.82E+06 |
| Cytobacillus kochii | 1.48E+06 |
| Streptomyces aculeolatus | 1.43E+06 |
| Saccharopolyspora gregorii | 1.43E+06 |
| Thermostaphylospora chromogena | 1.36E+06 |
| Luedemannella sp. | 1.22E+06 |
| Crossiella sp. | 9.19E+05 |

### EXAMPLES

### Example 1

In one experiment, a culture of PGPB containing blend was produced and applied to a walnut grove to determine its effectiveness as a replacement for conventional fertilizer.

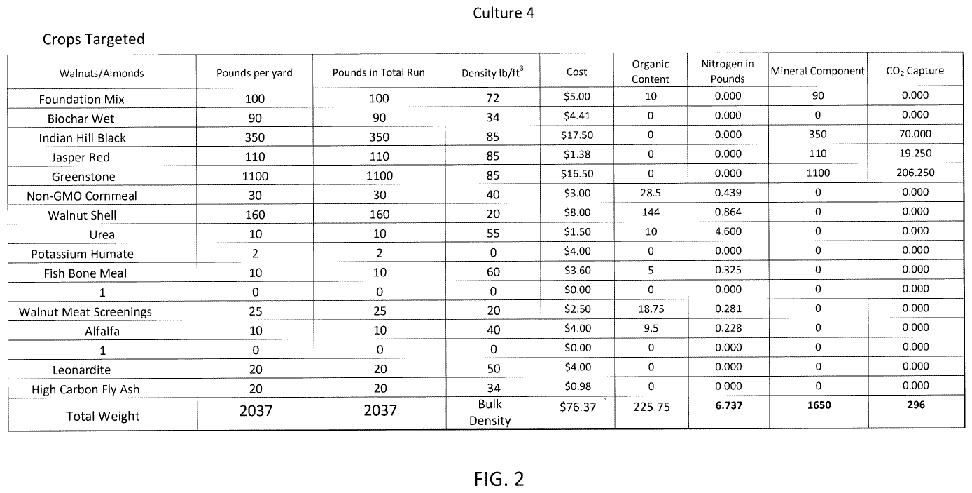

One ton batches were made as follows: 100 pounds of a pre-reacted batch plus 225 pounds of plant material into a pre-mixer and blended with 20 pounds of fly ash plus 20 pounds of Leonardite, 10 pounds of urea, 90 pounds of wet bichar (40% moisture) and 10 pounds of fish bone meal. The mixture was transferred to a conveyor where 1560 pounds of rock dust were added. The combined ingredients were then passed through a hammer mill to reduce particle size to less than ⅛″ in the long direction. Approximately 40 liters of water were added to the mixture to obtain a 10% moisture level depending on the incoming moisture content. The mixture was then moved to storage. After reacting for a week, the mixture was conveyed to a second area where it was aerated to increase oxygen exposure. The mixture was then turned a week later and monitored for temperature increase. When the temperature increase was less than 1.0° C. per day, the process was ceased and the material was stored and shipped. During the process, average free ammonia was in a range of 300 to 2000 ppm as measured against gross weight or 1000-20,000 ppm as measured by the weight of the water in the mix. Moisture average was kept between 7 and 15%. Average pH was in the range of 8.5 to 9.3. Total culture time was one month. The components of an example batch, Culture 4, are shown in the table of FIG. 2.

Culture 4 was a 1 ton batch that was made using the components listed in FIG. 2 and was designed to promote the growth of walnuts and almonds. Foundation mix from a previous culture as a starter that contained the PGPB that the culture is designed to grow. When a foundation mix is not available the plant component can be increased to make up the mass difference. The PGPB will be present in the plant material but at concentrations several degrees of magnitude lower. Thus, the use of a foundation mix can accelerate production by a factor of 2× or more, equivalent to, for example, a reduction of one or two months of production time.

In addition to the foundation mix, Culture 4 included several inorganic additives including 90 lbs of wet biochar, 350 lbs of Indian Hill Black, 110 lbs of Jasper Red and 1100 lbs of Greenstone. Plant material included 30 lbs of non-GMO cornmeal, 160 lbs of walnut shell, 25 lbs of Walnut meat screenings and 10 lbs of alfalfa. The mix further included 2 lbs of potassium humate, 10 lbs of fish bone meal, 20 lbs of high carbon fly ash and 10 lbs of urea. It is notable that a total of about 6.7 lbs of nitrogen, or 0.0335%, by weight, was the total in the 2000 lb batch. The PGPB populations of this batch are represented in Table 1, above.

The material of culture 4, or other cultures made by the same process, were applied to various crops to determine the effect on yield. All of the crops, with the exception of the hayfield, had been previously grown using nitrogenous fertilizers. In many of the tests, nitrogenous fertilizer application amounts were cut in half and the PGPB culture was applied at rates ranging from 600 lbs/acre to 1200 lbs/acre.

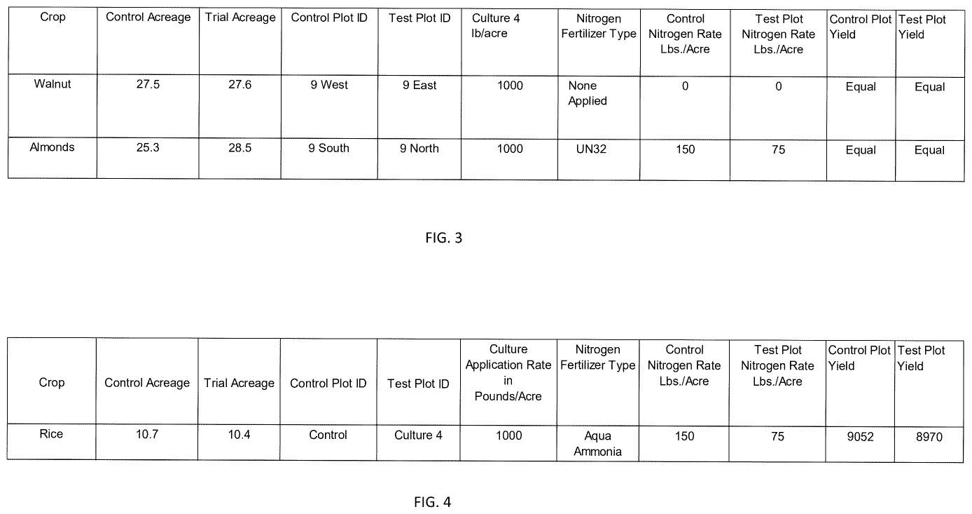

The results for Trial 1 are provided in the table of FIG. 3. This test was run on walnut and almond groves. Leaf tissue nitrogen in the walnut leaves increased 12% and phosphorus was also measurably higher. In the almonds, an equivalent yield was obtained when half of the nitrogen based fertilizer UN32 (75 lb per acre) was replaced with 1000 lb/acre of Culture 4. Note that the cost of 75 lb of nitrogen fertilizer is about $75 dollars and the cost of 1000 lb of Culture 4 is about $55.

Trial 2 was on a rice crop and results are summarized in the table of FIG. 4. The test plot involved the application of 1000 lb per acre of Culture 4 with 75 lb per acre of aqua ammonia. The control plot was treated with 150 lb per acre of aqua ammonia, the grower's standard treatment. As shown in the table, the yield results were comparable between the control and the Culture plot, well within one standard deviation. The relative cost savings of reducing the aqua ammonia use by half would be about $50/acre.

FIG. 5 is a table showing the results of a trial on a prune crop. As with the other trials, the amount of nitrogen applied was cut in half on the plots where the Culture was applied. The plots with less nitrogen, and 1000 lb/acre of Culture 4, showed slightly increased yield over the conventionally fertilized plots.

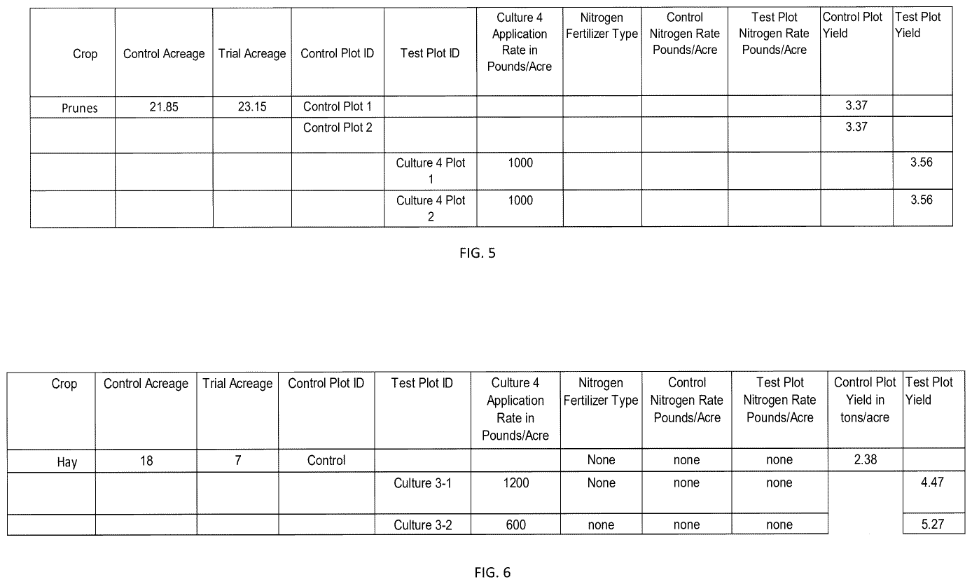

FIG. 6 provides the results of a hay field trial. The control plot used no fertilizer and Culture plot 3-1 was treated with 1200 lb/acre of Culture 3 and plot 3-2 was treated with 600 lb/acre of Culture 3. Both of the Culture 3 treated plots provided about double the yield of the control, and the plot treated with only 600 lb/acre of Culture 3 provided even better yield than the plot using 1200 lb/acre.

Each of the trials detailed above illustrates that a culture containing high concentrations of PGPB can replace the use of nitrogen based fertilizers either partially or entirely. It is believed that various cultures can provide improved results at application levels as low as 200 lb/acre, 100 lb/acre, 50 lb/acre, 10 lb/acre or even 2 lb/acre.

### Application

The culture can be stored or shipped dry and still retains its ability to promote plant growth. It can be applied using methods known to those of skill in the art. For example, the culture may be spread on a field using a manure or lime spreader. The amount of material to be applied is a factor of a number of variables including the crop being treated, the amount of nitrogen being replaced, and the concentration of PGPB in the culture. In some instances, an application rate of 2 to 10 lb/acre, 10 to 50 lb/acre, 10 to 250 lb/acre, or 100 to 1000 lb/acre may replace 50% or more of traditional fertilizer use.

### Additional Examples

In Example 1, a of producing a culture for enhanced crop yield in plants is provided, the method comprising providing a plant material or bacteria from a target crop, adding a nitrogen source to the plant material to produce a blend, excluding oxygen from the blend to produce a reduced oxygen environment having an average oxygen content of less than 0.1%, 0.2%, 1.0% or 2%, maintaining a free ammonia (NH₃) level of greater than 100, greater than 500, greater than 750 or greater than 1000 ppm in the blend, and maintaining a pH of the blend above 7.0, 8.0 or 9.0.

Example 2 is Example comprising adding between 0.01% and 98% by weight inorganic carrier.

Example 3 is Example 1 wherein the culture comprises between 2% and 100% plant material by weight.

Example 4 is Example 1 wherein the culture comprises between 5 and 20% plant material by weight.

Example 5 is Example 2 wherein the inorganic carrier is derived from at least one of basalts, shales, clays, granites, zeolites and mantel rock.

Example 6 is the method of any of the previous examples further comprising alternating the anaerobic environment with an aerobic one by introducing oxygen.

Example 7 is the method of any of the previous examples further comprising removing a portion of the culture, and inserting the portion into a second culture.

Example 8 is the method of any of the previous examples comprising maintaining for at least one day a pH of 9.0 or higher and a total ammonia concentration of at least 2000 ppm.

Example 9 is the method of any of the previous examples wherein the plant material has a carbon to nitrogen ratio from 10/1 to 100/1 wt/wt.

Example 10 is the method of any of the previous examples further comprising stopping the cycle when a temperature of the culture stops rising.

Example 11 is the method of any of the previous examples wherein 99% of the finished blend passes through a 0.5 inch sieve, a 0.25 inch sieve or a 0.125 inch sieve.

Example 12 is the method of any of the previous examples wherein the blend reaches a pH of 8.5, 9, 9.5, 10 or higher.

Example 13 is the method of any of the previous examples wherein the blend has a concentration level of ammonia, during production, that ranges between 2 ppm to 20,000 ppm, 100 to 20,000 ppm, 500 to 20,000 ppm or 1,000 to 20,000 ppm.

Example 14 is the method of any of the previous examples wherein the carrier includes at least 0.25%, by weight, of iron and manganese and at least 0.001%, by weight, of copper and zinc.

Example 15 is the method of any of the previous examples wherein the plant material is derived from at least one of wheat, corn, rye, nut trees and pasture grasses.

Example 16 is the method of any of the previous examples further comprising maintaining an aerobic condition for at least two minutes, at least 1 hour, at least one day, at least 3 days or at least one week.

Example 17 is the method of any of the previous examples further comprising converting inaccessible metal oxides from the trace metals to metal salts.

Example 18 is the method of any of the previous examples wherein the culture includes plant growth-promoting bacteria (PGPB) at a concentration that is more than 10×, more than 100× or more than 1000× the concentration of plant growth promoting bacteria in the raw components.

Example 19 is the method of any of the previous examples wherein the culture includes plant growth-promoting bacteria a concentration of greater than 5×10⁸, greater than 1×10′ or greater than 1×10¹⁰ cfu per gram of blend.

Example 20 is the method of any of the previous examples wherein the plant growth-promoting bacteria include both nitrogen fixing and phosphorus solubilizing bacteria.

Example 21 is the method of any of the previous examples wherein the method promotes the growth of plant growth-promoting bacteria and retards the growth of methanogens and/or fungi.

Example 22 is the method of any of the previous examples further comprising applying the blend to a live crop comprising the target crop.

Example 23 is the method of any of the previous examples wherein the plant material has not been sterilized.

Example 24 is the method of any of the previous examples comprising inoculating with a source of natural bacteria.

Example 25 is the method of any of the previous examples wherein the plant growth promoting bacteria include ammonia Oxidizing, nitrate reducing, monooxygenase (AMO), nitrogenase (nif), or urease or Dissimilatory nitrate reduction genetics.

Example 26 is the method of any of the previous examples wherein culturing is carried out in a conical pile, a rotary reactor or on an aerated floor.

Example 27 is the method of any of the previous examples wherein the blend is mixed during culturing.

Example 28 is the method of any of the previous examples wherein the plant material is cultured until the temperature stops increasing.

Example 29 is the method of any of the previous examples wherein the plant material is cultured for a period of more than one week, two weeks or one month.

Example 30 is the method of any of the previous examples wherein the temperature of the blend rises to greater than 40° C., greater than 50° C., greater than 60° C. or greater than 70° C.

Example 31 is a culture comprising greater than 1×10⁶, 1×10⁷, or 1×10⁸ cfu per gram of plant growth-promoting bacteria, a pH of greater than 8.0, and a free ammonia concentration of greater than 100 ppm.

Example 32 is Example 31 wherein the culture is in a conical pile.

Example 33 is Example 31 comprising an inorganic carrier and plant material.

Example 34 is any of Examples 31-33 wherein the inorganic carrier is derived from at least one of Basalts, Shales, clays, granites, Zeolites and mantel rock.

Example 35 is any of Examples 31-34 wherein the plant material is derived from at least one of wheat, corn, rye, rice, nut trees and pasture grasses.

Example 36 is any of Examples 31-35 comprising greater than 1000 ppm, greater than 2000 ppm, greater than 5000 ppm, greater than 10000 ppm, or greater than 100,000 ppm of halogen ions.

Example 37 is any of Examples 31-36 comprising greater than 1000 ppm, greater than 2000 ppm, greater than 50,000 or greater than 150,000 ppm of total dissolved solids.

Example 38 is any of Examples 31-37 comprising at least 5%, 10%, 15%, 20%, 25% or 30% moisture by weight.

Example 39 is any of Examples 31-38 comprising an inorganic carrier.

Example 40 is any of Examples 31-39 wherein an inorganic carrier is selected from at least one of sand, gravel, crushed stone, soil, clay and sediment.

Example 41 is any of Examples 31-40 wherein the plant growth-promoting bacteria are selected from one or more of facultative anaerobes, anaerobic bacteria, nitrogen fixing bacteria and AMOA bacteria.

Example 42 is any of Examples 31-41 wherein the plant growth-promoting bacteria are selected from one or more of, two or more of, five or more of or 10 or more of: Pseudogracilibacillus auburnensis, Staphylococcus lentus, Enteractinococcus sp., Pseudogracilibacillus endophyticus, Sinibacillus sp., Atopostipes sp., Jeotgalicoccus sp., Oceanobacillus indicireducens, Dietzia aerolata, Oceanobacillus sp., Nocardiopsis dassonvillei, Streptomyces griseus, Streptomyces albus, Streptomyces albidoflavus, Paeniglutamicibacter sulfureus, Saccharopolyspora rectivirgula, Brevibacterium sp., Saccharopolyspora sp., Nocardiopsis composta, Rhodococcus erythropolis, Nocardiopsis salina, Streptomyces aculeolatus, Saccharopolyspora gregorii, Anaerosalibacter bizertensis, Caldicoprobacter sp., Tepidimicrobium sp., Anaerosalibacter massiliensis, Sporosarcina sp., Pseudogracilibacillus endophyticus, Virgibacillus sp., Planifilum composti, Brachybacterium paraconglomeratum, Georgenia sp., Glutamicibacter nicotianae, Sphaerobacter thermophilus, Nocardiopsis sp., Filomicrobium sp., Haloactinobacterium album, Saccharomonospora viridis, Glycomyces mongolensis, Novibacillus thermophilus, Planifilum sp., Oceanobacillus sp., Nocardiopsis dassonvillei, Saccharomonospora azurea, Caldalkalibacillus sp., Kroppenstedtia eburnea, Rhabdanaerobium thermarum, Oligoflexus sp., Thermoactinomyces khenchelensis, Mycolicibacterium thermoresistibile, Laceyella sacchari, Thermocrispum municipale, Caldalkalibacillus uzonensis, Cellulosimicrobium cellulans, Patulibacter sp., Thermoactinomyces sanguinis, Cytobacillus kochii, Thermostaphylospora chromogena, Sporosarcina sp., Filomicrobium sp., Nocardiopsis dassonvillei, Streptomyces griseus, Mycolicibacterium thermoresistibile, Streptomyces albus, Streptomyces albidoflavus, Alkalihalobacillus clausii, Bacillus farraginis, Streptomyces aculeolatus, Staphylococcus lentus, Sporosarcina sp., Virgibacillus sp., Nocardiopsis sp., Nocardiopsis dassonvillei, Streptomyces griseus, Streptomyces albus, Streptomyces albidoflavus, Paeniglutamicibacter sulfureus, Saccharopolyspora rectivirgula, Brevibacterium sp., Alkalihalobacillus clausii, Rhodococcus erythropolis, Bacillus farraginis, and Streptomyces aculeolatus.

Example 43 is any of Examples 31-42 wherein at least one of the listed bacteria is present at greater than 10⁶, 10⁷, 10⁸ or 10⁹ cfu/g.

Example 44 is any of Examples 31-43 wherein the total count of listed bacteria is greater than 10⁶, 10⁷, 10⁸ or 10⁹ cfu/g.

Example 45 is any of Examples 31-44 wherein the bacteria include bacteria tolerant of ammonia at a concentration of greater than 100 ppm, greater than 1,000 ppm or greater than 10,000 ppm free ammonia.

Example 46 is any of Examples 31-45 wherein the bacteria include bacteria tolerant of salt at a wt/wt concentration of greater than 100 ppm, greater than 1,000 ppm, greater than 10,000 ppm or greater than 100,000 ppm total salt.

Example 47 is a method of improving the growth of plants comprising applying the culture of any of Examples 31-46 to a crop.

Example 48 is Example 47 comprising applying the culture at a rate of greater than 2 lb/acre, greater than 10 lb/acre, greater than 50 lb/acre or greater than 100 lb/acre per growing season.

Example 49 is either Example 47 or 48 comprising applying the culture at a rate of less than 2,000 lb/acre, less than 1,000 lb/acre, less than 500 lb/acre, less than 200 lb/acre, less than 50 lb/acre or less than 10 lb/acre per growing season.

Example 50 is any of Examples 1-30 comprising adding urea to the culture.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

What is claimed is:

1. A method of producing a culture for enhanced crop yield in plants, the method comprising:
providing a plant material or bacteria from a target crop;
adding a nitrogen source to the plant material to produce a blend;
excluding oxygen from the blend to produce a reduced oxygen environment having an average oxygen content of less than 0.1%, 0.2%, 1.0%, 2% or 5%;
maintaining a free ammonia (NH₃) level of greater than 100, greater than 500, greater than 750 or greater than 1000 ppm in the blend; and
maintaining a pH of the blend above 7.0, 8.0 or 9.0.

2. The method of claim 1, comprising adding between 0.01% and 98% by weight inorganic carrier.

3. The method of claim 1, wherein the culture comprises between 2% and 100% plant material by weight.

4. The method of claim 1, wherein the culture comprises between 5 and 20% plant material by weight.

5. The method of claim 1 further comprising alternating the anaerobic environment with an aerobic one by introducing oxygen.

6. The method of claim 1 further comprising:
removing a portion of the culture; and
inserting the portion into a second culture.

7. The method of claim 1 comprising maintaining for at least one day a pH of 9.0 or higher and a total ammonia concentration of at least 2000 ppm.

8. The method of claim 1, wherein the plant material has a carbon to nitrogen ratio from 10/1 to 100/1 wt/wt.

9. The method of claim 6, further comprising:
stopping the cycle when a temperature of the culture stops rising.

10. The method of claim 1, wherein 99% of the finished blend passes through a 0.5 inch sieve.

11. The method of claim 1, wherein the blend reaches a pH of 10 or higher.

12. The method of claim 1, wherein the blend has a concentration level of ammonia, during production, that ranges between 2 ppm to 20,000 ppm.

13. The method of claim 1, wherein the carrier includes at least 0.25%, by weight, of iron and manganese and at least 0.001%, by weight, of copper and zinc.

14. The method of claim 1, wherein the plant material is derived from at least one of wheat, corn, rye, nut trees and pasture grasses.

15. The method of claim 6, further comprising maintaining an aerobic condition for at least two minutes to three days.

16. The method of claim 1, further comprising converting inaccessible metal oxides from the trace metals to metal salts.

17. The method of claim 1 where the culture includes plant growth-promoting bacteria at a concentration that is more than 10× the concentration of plant growth promoting bacteria in the sum of the raw components.

18. The method of claim 1 wherein the culture includes plant growth-promoting bacteria at a concentration of greater than 5×10⁸ cfu per gram of blend.

19. The method of claim 1 wherein the plant growth-promoting bacteria include both nitrogen fixing and phosphorus solubilizing bacteria.

20. The method of claim 1 wherein the method promotes the growth of plant growth-promoting bacteria and retards the growth of methanogens and/or fungi.

21-51. (canceled)
